(19) United States
(12) Patent Application Publication
(10) Pub. No.: US 2007/0106771 A1
(43) Pub. Date: May 10, 2007

(54) Reconciliation of independently updated distributed data

(75) Inventors: Jeffrey S. Lucash, Hurley, NY (US); Robert Miller, Rochester, MN (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 11/272,221

(22) Filed: Nov. 10, 2005

(51) Int. Cl. G06F 15/173

(52) U.S. Cl. 709/223

(57) ABSTRACT

Independently updated data of a distributed communications environment is reconciled to provide consistent data to a plurality of members of the environment, such as a plurality of members of a cluster of a clustered environment. The data is reconciled using locally monotonically increasing values. One type of locally monotonically increasing value used in reconciling inconsistent data is a local timestamp.

### TECHNICAL FIELD

This invention relates, in general, to distributed communications environments, and in particular, to reconciling independently updated distributed data of distributed communications environments.

### BACKGROUND OF THE INVENTION

Distributed communications environments include highly available, scalable systems that are utilized in various situations, including those situations that require a high-throughput of work or continuous or nearly continuous availability of the systems.

One example of a distributed environment is a clustered environment having one or more clusters. A cluster includes, for instance, a plurality of operating system instances that share resources and collaborate with each other to perform system tasks. In a clustered environment, information is often replicated, so that identical information is available on all members of the cluster. Maintaining the consistency of this data is difficult as members may be updated individually or in groups when all members are not present. Further, sundering (i.e., splitting) of such members into subgroups, which are not in communication, requires that updates made on different subgroups be reconciled when the sundering is repaired.

Currently, in order to allow updates, a centralized update log or a centralized data server is provided, or consistency is maintained by only allowing updates when a quorum of members is present. However, clustered members often wish to maintain distributed consistent information without reliance on a centralized store or a primary member. Further, the requirement of quorum is deficient, as is prevents processing when the quorum is not reached or is lost.

Based on the foregoing, a need exists for an enhanced capability for allowing updates and for reconciling independently updated distributed data in the absence of a central store or a quorum requirement.

### SUMMARY OF THE INVENTION

The shortcomings of the prior art are overcome and additional advantages are provided through the provision of a method of facilitating reconciliation of data of a distributed communications environment. The method includes, for instance, determining whether one set of distributed data of the distributed communications environment and another set of distributed data of the distributed communications environment are consistent, wherein the determining includes employing one or more locally monotonically increasing values in the determining; and updating at least one of the one set of distributed data and the another set of distributed data, in response to the determining, to reconcile one or more inconsistencies between the one set of distributed data and the another set of distributed data.

In another aspect of the present invention, a method of facilitating reconciliation of data of a clustered communications environment is provided. The method includes, for instance, initiating by a joining member a join to a cluster of the clustered communications environment, the cluster including at least one current member; providing by a current member of the at least one current member a current membership data structure to the joining member; determining by the joining member a set of deltas, the set of deltas including zero or more data inconsistencies between the joining member and the current member, the determining employing at least one locally monotonically increasing value; providing by the joining member the set of deltas and a joining member's membership data structure to the current member; determining by the current member a set of deltas, the set of deltas including zero or more data inconsistencies between the current member and the joining member, the determining employing at least one locally monotonically increasing value; resolving by the current member zero or more conflicts between the joining member's set of deltas and the current member's set of deltas to provide a resolved set of deltas; and providing the resolved set of deltas to one or more members of the cluster, including the joining member.

System and computer program products corresponding to the above-summarized methods are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of a communications environment incorporating and using one or more aspects of the present invention;

FIG. 2a depicts one example of a cluster of the communications environment of FIG. 1, in accordance with an aspect of the present invention;

FIG. 2b depicts one example of replicated information stored on a member and reconciled, in accordance with an aspect of the present invention;

FIG. 3 depicts one example of a membership table, in accordance with an aspect of the present invention;

FIG. 4 depicts one example of a data table, in accordance with an aspect of the present invention;

FIG. 5 depicts one embodiment of the logic associated with a member joining a cluster, in accordance with an aspect of the present invention;

FIG. 6a depicts one embodiment of the logic associated with a joining member determining deltas, in accordance with an aspect of the present invention;

FIG. 6b depicts one embodiment of the logic associated with a current member determining deltas, in accordance with an aspect of the present invention;

FIG. 7 depicts one embodiment of the logic associated with determining conflicts, in accordance with an aspect of the present invention;

FIG. 8 depicts one embodiment of the logic associated with replicating deltas, in accordance with an aspect of the present invention;

FIG. 9 depicts one embodiment of the logic associated with applying deltas, in accordance with an aspect of the present invention; and

FIG. 10 depicts one embodiment of the logic associated with processing metadata in order to benefit from one or more optimizations, in accordance with an aspect of the present invention.

### BEST MODE FOR CARRYING OUT THE INVENTION

In accordance with an aspect of the present invention, a capability is provided for facilitating reconciliation of independently updated distributed data of a communications environment. To reconcile the data, locally monotonically increasing values are employed. Examples of such values include a local counter, a local timestamp that is monotonically increasing, etc. It is assumed that a future value or timestamp does not precede an earlier value or timestamp (i.e., time does not flow backward).

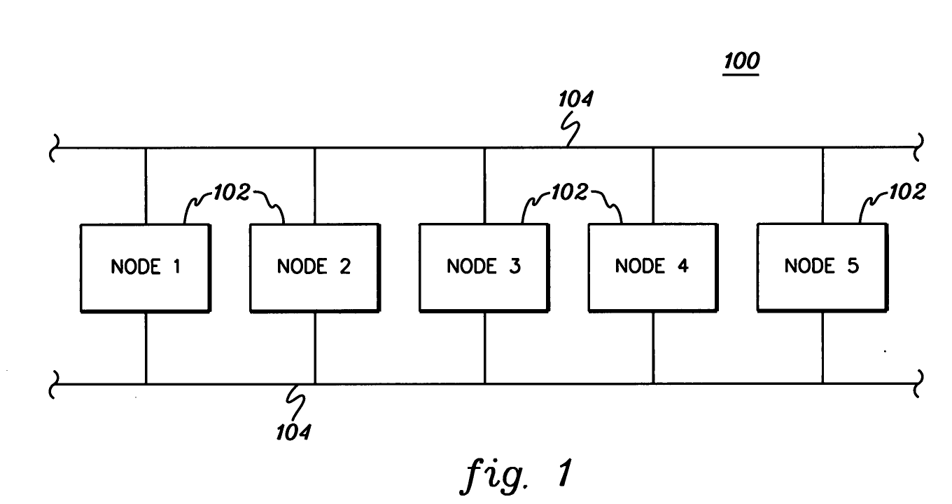

One example of a communications environment incorporating and using one or more aspects of the present invention is depicted in FIG. 1. A distributed communications environment 100 includes, for instance, a plurality of nodes 102 interconnected by a plurality of connections 104. As an example, nodes 102 are RS/6000s and connections 104 are local area network (LAN) connections coupling the nodes. As a further example, nodes 102 are personal computers interconnected by local area network (LAN) connections, switches, internet connections and/or other types of connections. Further, many other types of nodes and/or connections can be included in an environment that incorporates and uses one or more aspects of the present invention. Moreover, although five nodes are included in the environment of FIG. 1, this is only one example and only for illustration purposes. Communications environments may include any number of nodes, some or all of which are coupled to one another.

Communications environment 100 is, for instance, a clustered environment. In a clustered environment, there are one or more clusters formed of cluster members. The cluster members of a cluster share resources and collaborate with each other to perform tasks. Aspects of one example of a clustered environment are described in, for instance, a patent application, entitled “A Method, System And Program Products For Managing A Clustered Computing Environment,” Novaes et al., (Docket No. POU920000004US1), Ser. No. 09/583,677, filed May 31, 2000, which is hereby incorporated herein by reference in its entirety.

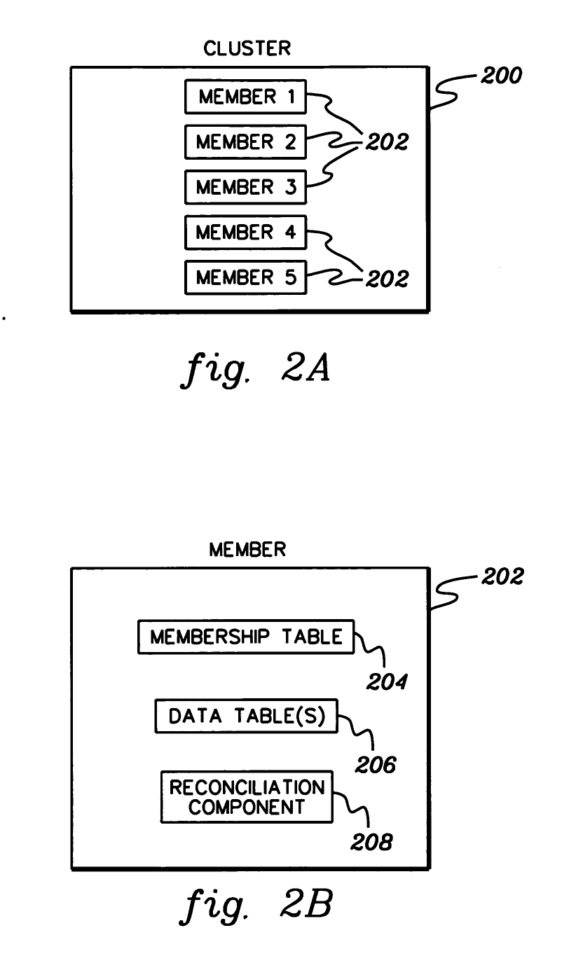

As one example, communications environment 100 includes a cluster 200 (FIG. 2) having a plurality of members 202. In this particular example, members 202 are nodes of the environment; however, in other examples, the members are entities other than nodes, such as virtual machines or other entities. Although cluster 200 is shown as having five members, this is only for illustration purposes. Cluster 200 can include one or more members, including all or a subset of the nodes (or other entities) of a communications environment.

In cluster 200, information is replicated on all the members of the cluster. Thus, each member 202 includes, for instance, a membership table 204 (FIG. 2b) and one or more data tables 206. The replicated information, including the membership tables and data tables, are maintained in synchronization, such that each member of the cluster has access to the same consistent information. To maintain this consistency, a reconciliation component 208 is used, as described in further detail below.

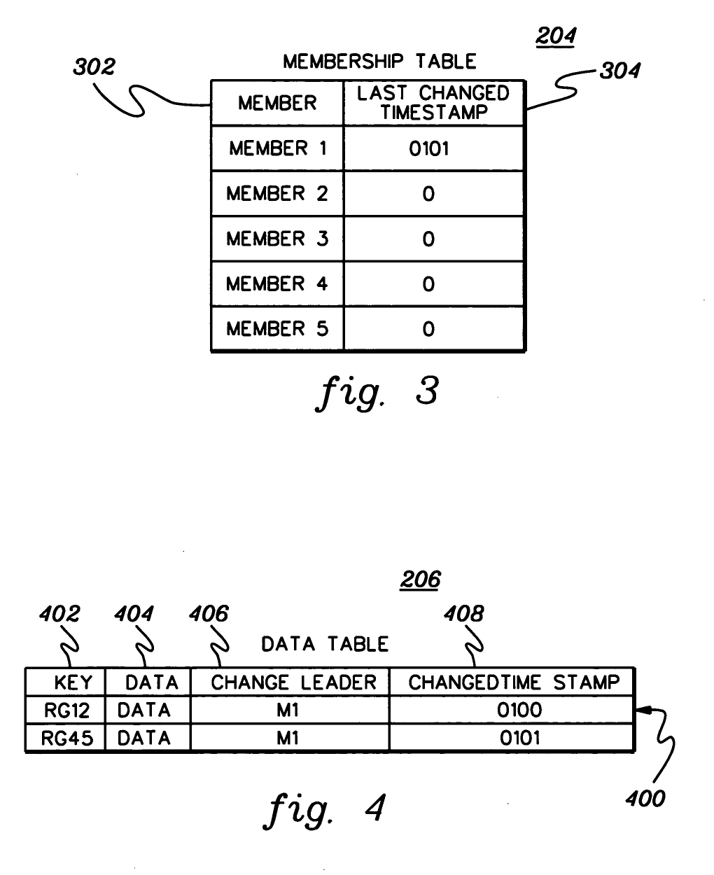

One example of membership table 204 is described with reference to FIG. 3. Membership table 204 includes, for instance, a list of the members 302 included in the cluster; and a last changed timestamp (LCTS) 304 for each member 302. The last changed timestamp indicates the most recent time that the member associated with the last changed timestamp was a change leader for a row of data of a data table. The last changed timestamp is a local (node specific) time and not a cluster-synchronized time. This value is monotonically increasing, and thus, is not a time-of-day value, but rather, the underlying value of the timer itself. Membership table 204 may also include other information.

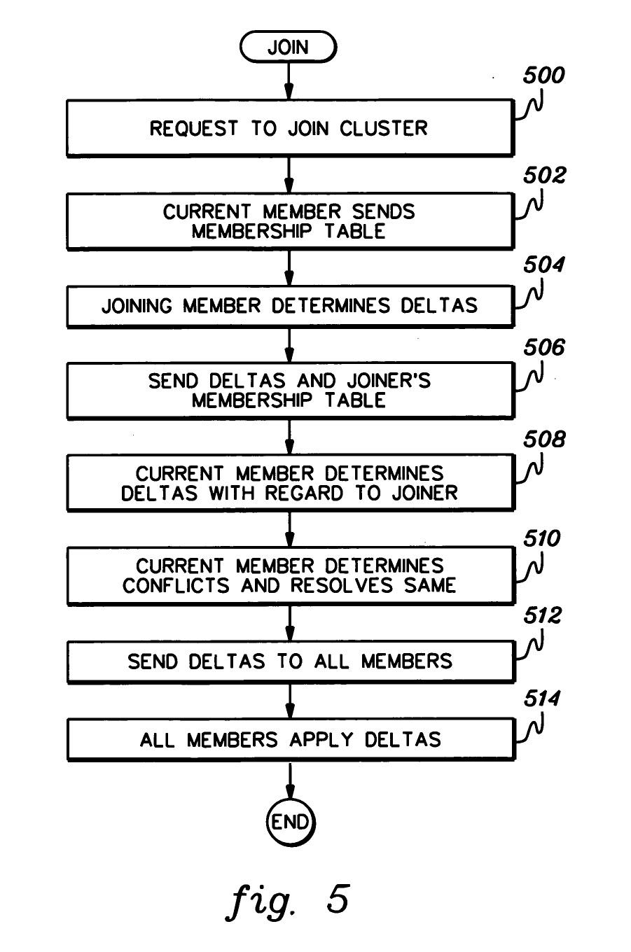

One example of data table 206 is described with reference to FIG. 4. Data table 206 includes a plurality of rows of data 400 (FIG. 4), each row including, for instance, a key 402 uniquely identifying the row of data; data 404; a change leader 406 indicating the member responsible for initiating a change to the data row; and a change timestamp (CTS) 408 specifying the time of the change. In one embodiment, there is only one change leader per cluster at a time. However, in other embodiments, more than one change leader is active at a time.

Reconciliation component 208 (FIG. 2b) uses the membership table and data tables in reconciling information that has been independently updated and not reflected at one or more members of the cluster. This occurs when, for example, a member of the cluster loses communication with the other members of the cluster and updates are made either in the cluster or at the separated member. When the member is brought back in communication with the other members, the member's information and the other members' information are reconciled.

As a further example, reconciliation is employed when members of a cluster are active at disjoint points in time. For instance, assume Nodes 1 and 2 of a cluster of five nodes, Nodes 1-5, are active and then go down. Then, Nodes 3-5 of the cluster are active. When all of the members are active, reconciliation is used to reconcile the updates made by the two subgroups of the cluster, which had not communicated with one another, since updates were made by the separate subgroups.

To become an active member of a cluster, the member joins the cluster. As used herein, the term “join” refers to a member becoming active in the cluster at anytime. As examples, it includes the member becoming active in the cluster for the first time, since a reset of the system; and/or the member becoming active after a splitting of the cluster (i.e., sundering). Other examples may also exist and are considered to be incorporated within the definition of join and one or more aspects of the present invention.

In one embodiment, multiple members with differing changes may join simultaneously. In this situation, a current member of the cluster determines its changes with regards to all of the joining members.

The reconciliation component includes logic used to reconcile the inconsistent information. For instance, it includes join logic to join the member to the cluster, delta determining logic to determine any changes that are to be reconciled, logic to determine if there are any conflicts to be resolved, replicate logic to replicate the changes to all the members of the cluster (or a subset of the members, in another embodiment), and apply logic to apply the deltas that have been determined. Both data tables and membership tables are reconciled, if necessary. Further details regarding reconciliation are described below with reference to join processing.

A member joins a cluster to become an active member of the cluster. For instance, Member 1 may be a member of Cluster A, but it may not be in communication with other members of the cluster, and therefore, it is an inactive member of the cluster. To become an active member, Member 1 joins the cluster. The member can request to join the cluster any time the member is capable of communicating with the other members of the cluster. Thus, even if the member joins and then fails, it can join again.

During join processing, the member requesting to join the cluster determines what information it has that is inconsistent with the cluster's information. This is referred to as delta processing. Also, the cluster determines whether there is any information that the cluster has that is inconsistent with the joiner. Again, this is referred to as delta processing.

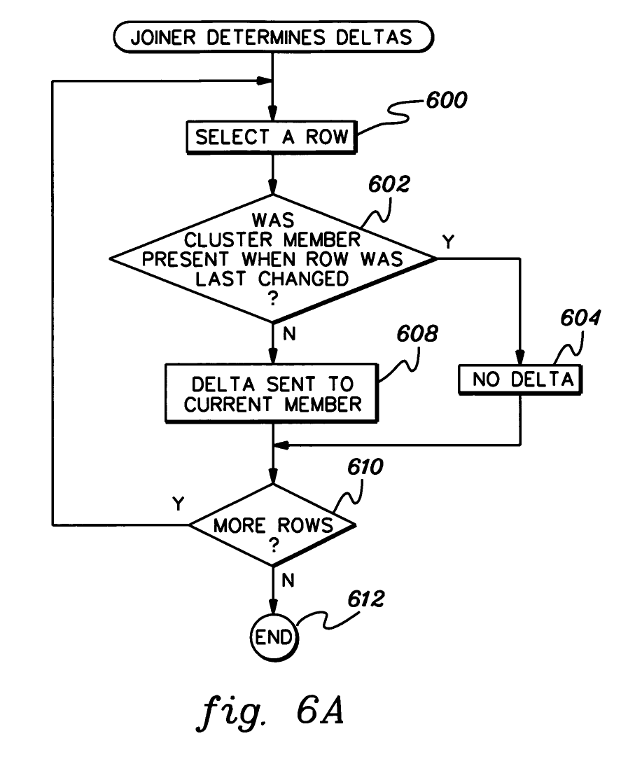

One embodiment of the logic associated with join processing is described with reference to FIG. 5. Initially, a request is made to join the cluster, STEP 500. In this example, the request is made by a member of the cluster that has regained communication with the cluster. The member requesting to join is referred to herein as the joining member or joiner.

In response to the join request, a current member of the cluster (e.g., the cluster leader) sends the current membership table to the joining member, STEP 502. The joining member uses the membership table to determine its set of deltas-relative to the tables currently being used in the cluster it is joining, STEP 504. For instance, the joining member uses the membership table it received to determine for each row in each data table maintained by the joining member whether the row is a delta (e.g., change) that is to be processed by the existing members.

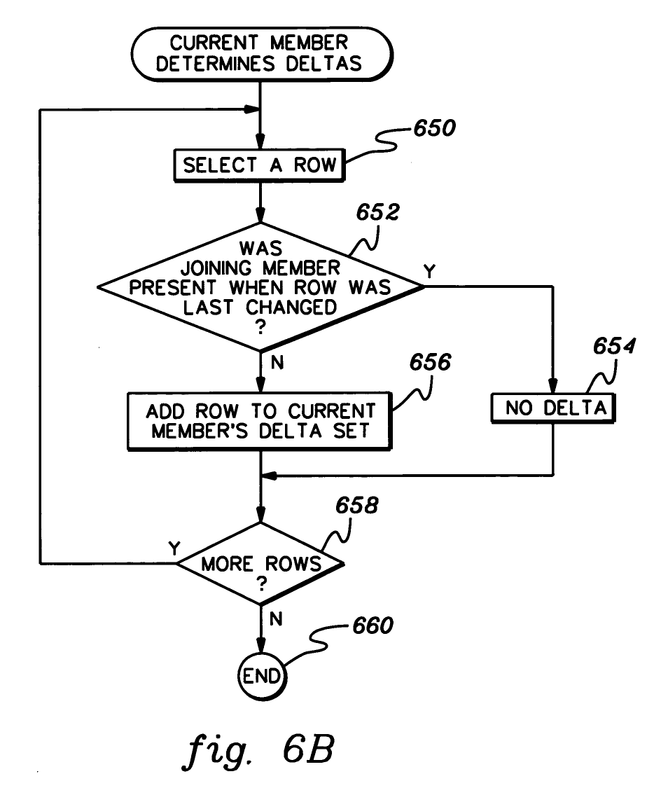

Deltas are determinable in many ways. In one example, processing is performed, as described with reference to FIG. 6a. Initially, a row of a data table of the joining member is selected for processing by the joining member, STEP 600. A determination is made as to whether the current member was present in the cluster when the row was last modified, INQUIRY 602. The current member was present if the change leader (CL) for that row is present in the current member's membership table (CMT), and if the last change timestamp (LCTS) for that change leader in the current member's membership table (CMT) is greater than or equal to the changed timestamp (CTS) of the data row (i.e., CMT[row.CL].LCTS>=row.CTS, where a row in a table is indicated using array notation similar to C++, the array index is the table key, and fields within the row are indicated using a dot(.)).

If the current member was present when the row was last changed, then the row is not a delta, STEP 604. However, if the current member was not present when the row was last changed, then the row is a delta that is sent to the current member, STEP

The current member maintains this delta in a joining member's delta set to be used in further processing, as described below.

Subsequently, a determination is made as to whether there are more rows to be processed, INQUIRY 610. If so, processing returns to STEP 600. Otherwise, delta processing for the joining member is complete, STEP 612.

Returning to FIG. 5, the deltas (e.g., the changed rows of the data tables), if there are any, and the joining member's membership table are sent to the current member, STEP 506.

In addition to the above, the current member determines whether it has any deltas with regard to the joining member, STEP 508. One embodiment of this logic is described with reference to FIG. 6b. Initially, a row of a data table of the current member is selected for processing by the current member, STEP 650, and a determination is made as to whether the joining member was in the cluster when the row was last modified, INQUIRY 652. The joining member was present if the change leader (CL) for that data row is present in the joining member's membership table (JMT), and if the last change timestamp (LCTS) for that change leader in the joining member's membership table is greater than or equal to the CTS of the row (i.e., JMT[row.CL].LCTS>=row.CTS). If JMT[row.CL].LCTS>=row.CTS, then the change is already known in the cluster. If the joining member was present when the row was last changed, then the row is not a delta, STEP 654. On the other hand, if the joining member was not present when the row was last modified, then the row is added to a current member's delta set created and maintained by the current member, STEP 656.

Thereafter, of if there was no delta, a determination is made as to whether there are more rows to be processed, INQUIRY 658. If there are more rows to be processed, then processing continues with STEP 650. Otherwise, processing associated with the current member determining its deltas is complete, STEP 660.

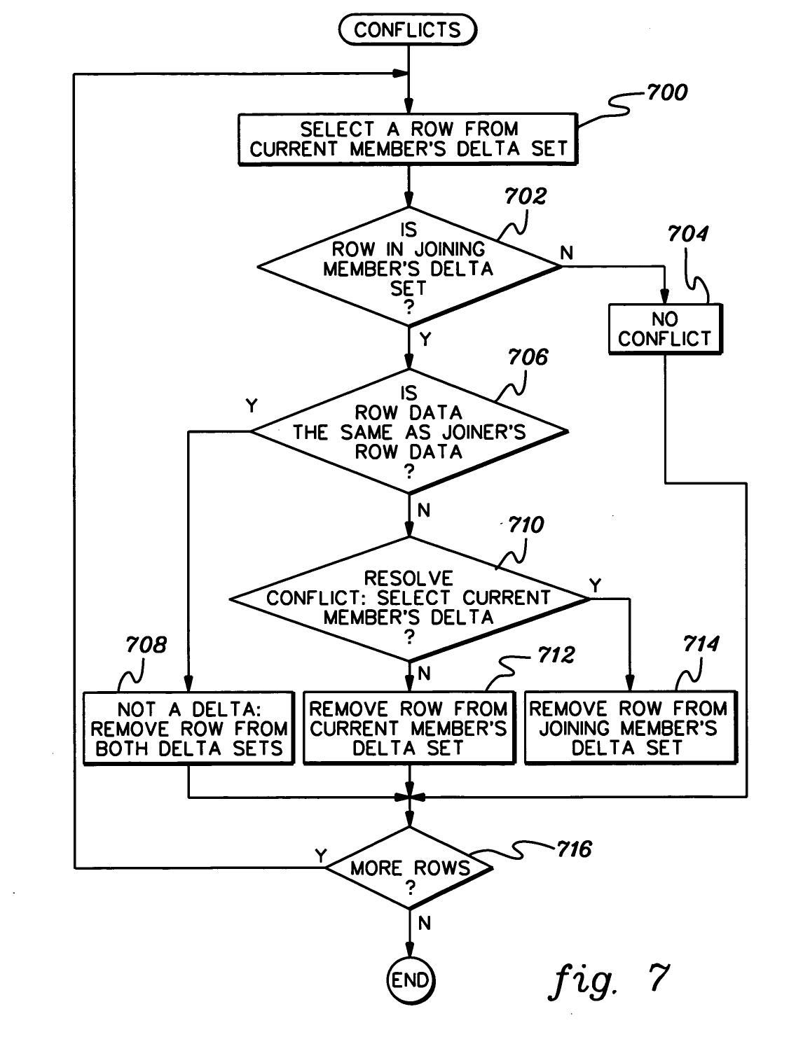

Returning to FIG. 5, subsequent to the current member determining its deltas with regards to the joining member, the current member, assuming there are deltas, determines whether there are any conflicts and resolves the same, if any, STEP 510. One embodiment of the logic associated with determining conflicts is described with reference to FIG. 7.

In one example, to determine if there is a conflict, a row is selected from the current member's delta set, STEP 700 (FIG. 7), and a determination is made as to whether the selected row is in the joining member's delta set, INQUIRY 702. If the row is not in the joining member's delta set, then there is no conflict, and the row can be added, as described below.

However, if the row is in the joining member's delta set, INQUIRY 702, then a further determination is made as to whether the data of that row is the same as the data of the joining member's row, INQUIRY 706. If the data is the same in both rows, then the row is not a delta, and the row can be removed from both of the delta sets, STEP 708.

Returning to INQUIRY 706, if the data in both rows is different, then there is a conflict, and a determination is made as to whether the conflict is resolved by selecting the current member's delta or the joining member's delta, INQUIRY 710. A row conflict can be handled in number of different ways, including arbitrarily, in which one of the two rows is selected as the current row; or programmatically, in which a program is written that determines the row to be used. The program references, for instance, the data tables on other members to make the decision. In one example, in selecting the row to use, a determination is made as to whether the change leaders of the two rows are the same. If so, a further determination is made as to whether the LCTS of the current member or the joining member is greater. The row associated with the greater LCTS is selected.

If it is determined that the current member's delta row is to be selected, then the row is removed from the joining member's delta set, STEP 714. However, if it is determined that the conflict is to be resolved by selecting the joining member's delta row, then the row is removed from the current member's delta set, STEP 712.

Subsequent to STEPs 704, 708, 712 or 714, a determination is made as to whether there are more rows to be processed, INQUIRY 716. If there are more rows to be processed, processing continues with STEP 700. Otherwise, conflict processing is complete.

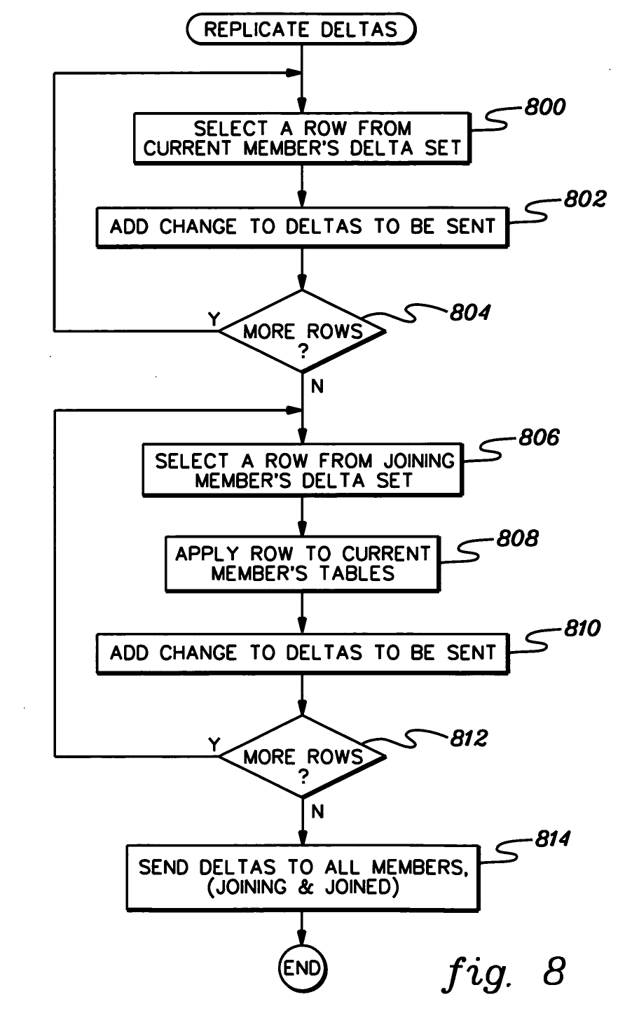

Returning to FIG. 5, subsequent to resolving the conflicts, the deltas (if any) are sent to all members, in this example, STEP 512. One embodiment of the logic associated with this processing is described with reference to FIG. 8. In the processing of FIG. 8, an accumulated set of deltas is created that includes the deltas from the current member's delta set and the joining member's delta set. This accumulated set is then sent to all the members of the cluster, in this example. (In another example, it is sent to a subset of members.)

Referring to FIG. 8, initially, a row is selected from the current member's delta set, STEP 800, and the change in the selected row is added to the accumulated delta set, STEP 802. Thereafter, a determination is made as to whether there are more rows in the current member's delta set to be processed, INQUIRY 804. If there are more rows to be processed, then processing continues with STEP 800; otherwise, the logic continues with processing the joining member's delta set.

A row is selected from the joining member's delta set, STEP 806, and that row is applied to the current member's tables, STEP 808. Additionally, the change is added to the accumulated delta set, STEP 810.

A determination is then made as to whether there are more rows of the joining member's delta set to be processed, INQUIRY 812. If there are more rows, then processing continues with STEP 806; otherwise, the accumulated delta set is sent to all of the members of the cluster, including the joining and joined members, STEP 814.

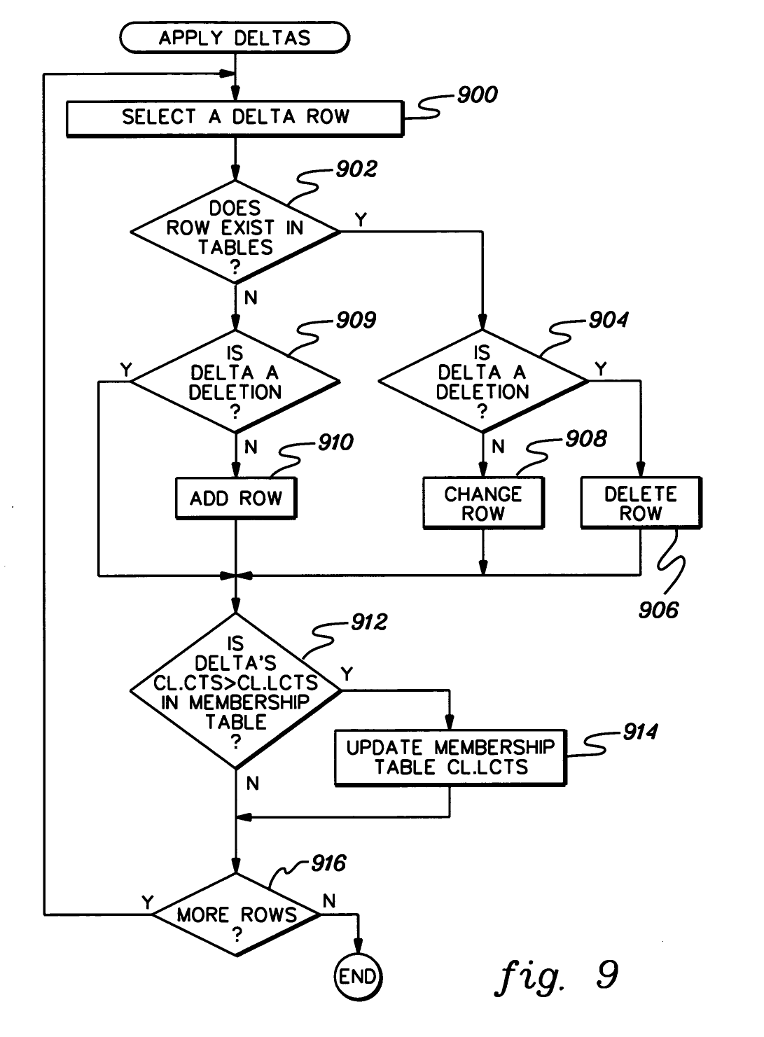

Returning to FIG. 5, subsequent to sending the deltas to all the members (assuming there are deltas to be sent), the deltas are applied, STEP 514. One embodiment of the logic associated with this processing is described with reference to FIG. 9. The processing of FIG. 9 is performed by each cluster member that receives the deltas.

Initially, a delta row is selected from the accumulated delta set, STEP 900, and a determination is made as to whether the row exists in a table of the member performing this processing, INQUIRY 902. If the row does exist in a table, then a further determination is made as to whether the delta is a deletion, INQUIRY 904. If it is a deletion, then the row is deleted, STEP 906; otherwise, the row is changed, STEP 908. Thereafter, processing continues with INQUIRY 912, as described below.

Returning to INQUIRY 902, if the row does not exist in a table, then a determination is made as to whether the delta is a deletion, INQUIRY 909. If the delta is a deletion and the row does not exist, then no processing of the row is needed, and processing continues with INQUIRY 912, as described below. However, if the row does not exist in the table and it is not a deletion, then the row is added, STEP 910, and processing continues with INQUIRY 912.

At INQUIRY 912, a determination is made as to whether the membership table is to be updated. As one example, a check is made as to whether the delta's change leader timestamp is greater than the last change timestamp of the change leader in the membership table (i.e., CL.CTS>CL.LCTS). If so, then the membership table is updated with the change leader's last changed timestamp, STEP 914. Thereafter, or if the membership table need not be updated, a determination is made as to whether there are more rows of the accumulated delta set to be applied, INQUIRY 916. If there are more rows to be applied, then processing continues with STEP 900; otherwise, the apply delta logic is complete. Thus, a two-phase commit process is used to commit the changes at all the members, thereby completing the join processing, assuming the commit is successful.

As described above, with the join processing, the change leader and changed timestamp information of the data tables combined with the membership table allows the determination of the relative sequencing of table changes. This provides a mechanism for ignoring rows which have been previously incorporated in a merged table.

In one embodiment, the current member replicates the updated tables whether or not the joining member had any deltas. This accounts for a joining member not having a data table or rows in the current member's data tables that are not in the joining member's data tables. If a member's membership table is deleted inadvertently (or maliciously), the join process still works. In this case, the member joins with no membership table. When the member joins a cluster, the join operation effectively causes entire tables to be transferred. This is also the case for a newly installed member freshly added to the cluster. If the member, however, is the first member to come up, the other members determine that their entire tables are deltas. In another embodiment, it can be determined that there is no data in the current member's tables, and instead, the joiner's tables are replicated.

In a further embodiment, there is more than one joining member. In this case, each joining member performs processing, as described herein, however, the current member determines if it has a delta relative to any of the joining members. This introduces an outer loop in the current member figure where the current member's data row is checked against each of the joining member's membership tables in determining the deltas, and a loop to examine each of the joining member's delta sets in determining conflicts and in removing the deltas not chosen after conflict resolution, as well as in removing the deltas from multiple joiner's delta sets when the deltas are the same.

Further, in applying the deltas, prior to changing a row, the member (current or joiner) is to check whether the change applies. Thus, if it's membership table (MT) [row.CL].LCTS==row.CTS, the change need not be processed and it can be skipped (as the one selected is from this node). This is done on every member during the processing as any of the current members or joining members may be in this forgetful state.

The steps involved in joining a cluster may vary depending on processing that has taken place, since the joining member has been inactive. Thus, various examples of the processing that takes place to effect a join are described below.

### EXAMPLE 1

### Simple Merge

This describes a sunder fix where the subclusters both select a current member to do the processing.

Five members: {N1-N5}. Change Leader=N1.

Membership table (MT) on all members:

| Member | LCTS |
|---|---|
| N1 | 0 |
| N2 | 0 |
| N3 | 0 |
| N4 | 0 |
| N5 | 0 |

LCTS == 0 indicates the member has not been a change leader
for any row.

Two data row entries created:

| Key | CL | CTS |
|---|---|---|
| RG12 | N1 | 0100 |
| CG5 | N1 | 0101 |

MT for cluster:

| Member | LCTS |
|---|---|
| N1 | 0101 |
| N2 | 0 |
| N3 | 0 |
| N4 | 0 |
| N5 | 0 |

The cluster then sunders (i.e., splits).
Subcluster A = {N1-N3}, CL = N1.
Subcluster B = {N4-N5}, CL = N4.

Subcluster A changes RG12:

| Key | CL | CTS |
|---|---|---|
| RG12 | N1 | 0200 |
| RG45 | N1 | 0101 |

MT for A:

| Member | LCTS |
|---|---|
| N1 | 0200 |
| N2 | 0 |
| N3 | 0 |
| N4 | 0 |
| N5 | 0 |

Subcluster B changes RG45:

| Key | CL | CTS |
|---|---|---|
| RG12 | N1 | 0100 |
| RG45 | N4 | 0200 |

MT for Subcluster B:

| Member | LCTS |
|---|---|
| N1 | 0101 |
| N2 | 0 |
| N3 | 0 |
| N4 | 0200 |
| N5 | 0 |

The network sunder is repaired and Subclusters A and B merge back into a full cluster {N1-N5}, CL =N1. Assume A's master, N1, is the current member. N1 sends to the selected joining member (N4) N1's MT. N4 will then compute a delta which it sends to N1. N1 will then determine, for each row in N's delta, if there is a conflict with that row.
This is described below:
1. N1.MT is sent to N4.
2. For each row in N4, determine if N4 has a delta.
   a. N4.RG12.CL=N1. N1.MT[N1].LCTS =0200, N4.RG12.CTS=0100. N1 is greater, so N1 has a more recent change. RG12 is not a delta.
   b. N4.RG45.CL=N4. N1.MT[N4].LCTS=0; N4.RH45.CTS=0200. N4 is greater, so RG45 is a delta.
3a. The delta from N4 (RG45) is sent to N1, along with N4.MT.
3b. N1 determines it deltas relative to N4. The check is not with each delta row, but rather each row in the data table relative to N4's MT. IF it is a delta, the deltas received from N4 can be checked to see if the row was a delta there and whether it has the same data values.
4. For each row in the delta, determine if there is a conflict.
   a. There is a row N1.RG45. N1.RG45.CL=N1. N4.MT[N1].LCTS=0101.
      N1.RG45.CTS=0101. They are equal, which means N4 knew about N1's version of RG45, so N4.RG45 is an updated row. N1 updates RG45 with the row from N4.
5. All data rows are merged, via the above. Membership rows are now merged. For each row in N1.MT, compare the same row in N4. Choose the row that has the greatest LCTS.
6. N1 now replicates both the MT and data tables.

### EXAMPLE 2

### Complex Merge

If the cluster {N1, N2, N3, N4, N5} has fully replicated data and membership tables, and then sunders into subcluster A {N1, N2, N3} and subcluster B {N4, N5}, each side knows the values of LCTS which was valid when the split occurred. Thus, if side A makes a change and defines RG12, that entry would have a CTS value greater than the previous LCTS for the row's CL. If side B (N4, N5) changes a previous entry for RG45, that entry would have a CTS that is also greater than the previous LCTS for the CL.

If the sunder were repaired and the two subclusters were to merge, side A would have a delta set of 1 row (RG12) and side B would have a delta set of 1 row (RG45). The side B delta when applied to side A will replace the row similar to the simple case above.

However, assume that N5 fails before the sunder is repaired. Then, when the sunder is fixed, member N4 would merge into subcluster A, so that the membership was {N1-N4}. The row delta would still be discovered and applied.

If N4 then dies, leaving a membership of {N1-N3} again, and row RG45 is modified again, it would receive an updated CTS. More importantly, the CL value for RG45 would change from N4 to N1. Note that there are now 3 separate sets of row RG45. Membership {N1-N3}, N4, and N5, and all have distinct CTS values.

If N5 then joins the cluster, N5 will discover that it has no deltas relative to the cluster, as the change to RG45 was applied when N4 joined. The cluster will discover that it has two changes (RG12 and RG45) relative to N5 that has to be applied. This example is further described below.

The network sunders into Subcluster A={N1-N3}, CL=N1 and Subcluster B={N4, N5}, CL=N4.

Membership table for A:

| Member | LCTS |
|---|---|
| N1 | 0101 |
| N2 | 0 |
| N3 | 0 |
| N4 | 0 |
| N5 | 0 |

Membership table for B:

| Member | LCTS |
|---|---|
| N1 | 0101 |
| N2 | 0 |
| N3 | 0 |
| N4 | 0 |
| N5 | 0 |

Data Rows on A and B:

| Key | CL | CTS |
|---|---|---|
| RG12 | N1 | 0100 |
| RG45 | N1 | 0101 |

A changes RG12:

| Key | CL | CTS |
|---|---|---|
| RG12 | N1 | 0200 |
| RG45 | N1 | 0101 |

B changes RG45:

| Key | CL | CTS |
|---|---|---|
| RG12 | N1 | 0101 |
| RG45 | N4 | 0200 |

N5 fails. A = {N1-N3}, B = {N4}.
N4 merges with A. A = {N1-N4}.
RG45 change on N4 is reflected into A.

Membership table A:

| Member | LCTS |
|---|---|
| N1 | 0200 |
| N2 | 0 |
| N3 | 0 |
| N4 | 0200 |
| N5 | 0 |

Data rows on A:

| Key | CL | CTS |
|---|---|---|
| RG12 | N1 | 0200 |
| RG45 | N4 | 0200 |

N4 fails. Add A = {N1-N3}.

A (N1-N3) change RG45:

| Key | CL | CTS |
|---|---|---|
| RG12 | N1 | 0200 |
| RG45 | N1 | 0201 |

Membership table A:

| Member | LCTS |
|---|---|
| N1 | 0201 |
| N3 | 0 |
| N3 | 0 |
| N4 | 0200 |
| N5 | 0 |

N5 joins side A.

Membership table for N5:

| Member | LCTS |
|---|---|
| N1 | 0101 |
| N2 | 0 |
| N3 | 0 |
| N4 | 0200 |
| N5 | 0 |

Data rows on N5:

| Key | CL | CTS |
|---|---|---|
| RG12 | N1 | 0101 |
| RG45 | N4 | 0200 |

1. N1.MT is sent to N5.
2. For each row in N5, determine if N5 has a delta.
   a. N5.RG12.CL=N1. N1.MT[N1].LCTS=0201, N5.RG12.CTS=0101. The CTS for row RG12 is less than the MT LCTS for N1, so the data row on N1 is more recent than the one on N5 and the row is not a delta.
   b. N5.RG45.CL=N4. N1.MT[N4].LCTS=0200, N5.RG45.CTS=0200.

The MT LCTS for N4 is the same as the CTS for N4 in row RG45, thus the row is not a delta.
3. No delta is sent to N1, but membership tables are still merged (in this case, N1's membership table would be unchanged). N1 still replicates the merged membership tables and the data table.

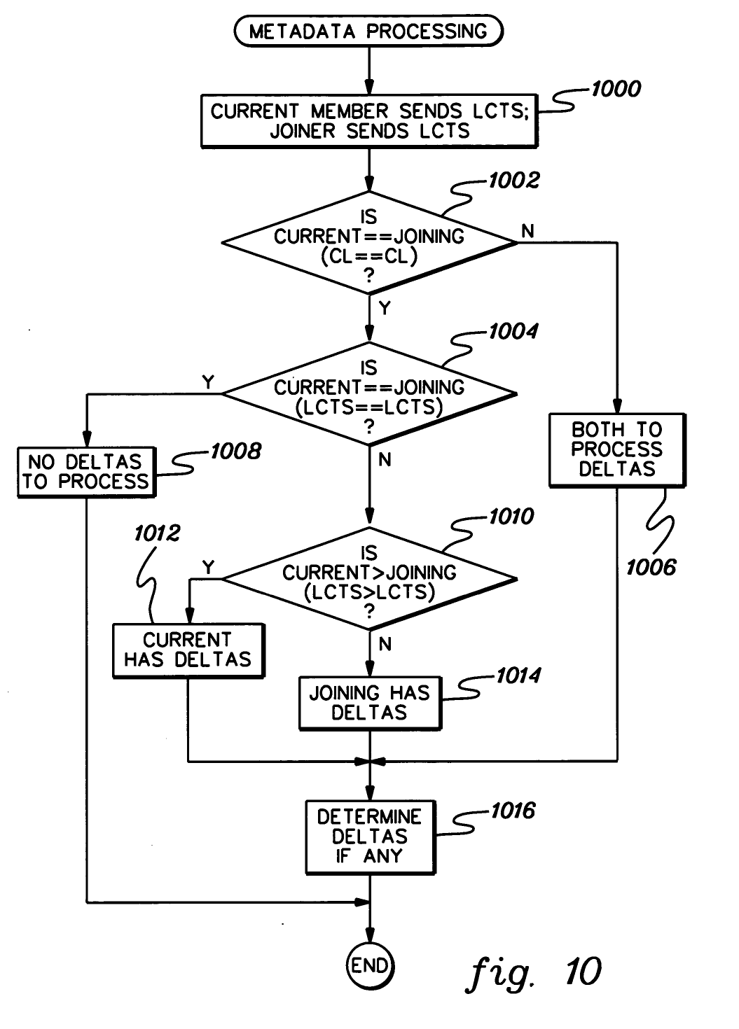

Although examples of join processing are described herein, variations to this processing are possible without departing from the spirit of the present invention. As one example, an optimization is provided in which the information processed and/or replicated is kept to a minimum. For instance, a determination is made at an early stage of processing (e.g., at an initial stage of join processing) as to whether there are any deltas to be processed. If there are no deltas, then processing ceases quickly. This is described in further detail with reference to FIG. 10.

Referring to FIG. 10, processing is performed at both the current member and the joining member, as described herein. Initially, the current member sends its last changed timestamp to the joining member, and the joiner sends its last changed timestamp to the current member, STEP 1000. Thereafter, each of the joining member and the current member makes a determination as to whether the change leader of the current member is equal to the change leader of the joining member. In this example, each member knows the change leader of the other member; however, in another embodiment, the change leader information is exchanged. If the change leaders are not equal, then the timestamps are not to be compared, so both the current member and the joiner are to process deltas, if any, STEP 1006. However, if the current member's change leader is equal to the joining change leader, then a further determination is made as to whether the current LCTS is equal to the joining LCTS, INQUIRY 1004. If so, then there are no deltas to be processed, STEP 1008, and processing is complete. However, if the current LCTS is not equal to the joining LCTS, then a further determination is made as to whether the current LCTS is greater than the joining member's LCTS, INQUIRY

If it is, then the current member may have deltas, STEP 1012. However, if the current member's LCTS is less than or equal to the joining LCTS, then the joining member may have deltas to be processed, STEP 1014. Should there be deltas that may need to be processed, STEPs 1006, 1014, then processing continues with determining if there are any deltas, as described above with reference to FIGS. 6a and 6b, STEP 1016.

In the above embodiment, if there are no deltas to be processed, then processing is complete. If either the joiner or the current member has deltas to be processed, then processing continues. The current member sends its tables' metadata (e.g., member id, CL, and LCTS) to the joiner, and the joiner sends its tables' metadata to the current member. Each metadata value is compared separately per table. Only those tables which have deltas are processed on either the current member or the joining member.

In the examples described above, it has been assumed that the presence of a member in the cluster indicates that any changes in which that member was the change leader were already merged. However, this would not be the case, if the data was lost on a particular member. For example, if the membership table on a member (e.g., node) was lost in its entirety by, for instance, table deletion or replacement, the member has forgotten the changes that were made when it was present as the change leader. This member is referred to as a forgetful member.

With a forgetful member, metadata is exchanged to allow this condition to be determined. When a change is made to a table, the timestamp for that change is saved as metadata in the table (CL.CTS), and as the metadata for the entire set of tables. Thus, each table records the last timestamp applied, and the membership table records the last timestamp applied to any table. When a member joins, this set of metadata is exchanged with the current cluster, and thus, it is possible to determine if it has forgotten any of its changes. For example, if a table (or tables) has been removed, the metadata timestamp will be exchanged as CL=0, CTS=0. This immediately implies that the tables contained on the cluster members should be utilized without regard to any deltas. If the member is the first one to join the cluster, joining members would detect that the entire data table or tables are to be treated as deltas and exchanged with the current member.

To handle the case where a table was moved or restored from a different member, the table metadata also contains the member identification. Thus, on boot, the member is able to determine if the table was created on itself, and if not, the table is ignored and removed—to be replaced with the current information contained in the cluster of the joining members.

If a member's system time was reset, such that the time values are no longer monotonically increasing, this is discovered as well, so that changes are not made with incorrect timestamps. To handle this, the metadata for the membership table also contains an entry for the LCTS made by the member itself. Thus, on boot, if the metadata LCTS is less than the system time, the value to be used is the LCTS+1 until such time as the system time either is reset to a correct value or the system time catches up with the change counter. This ensures that the values remain monotonically increasing.

If both conditions occur, the system time is reset and the tables are restored to a prior image, some changes for which the member was the change leader may be present in the cluster with a CTS value that is greater than the monotonically determined value in use by the member. In this case, the resolved membership table, which is replicated, includes an LCTS value, which is later than the monotonically increasing value that is in use on the member. When this is detected, the value is reset to the LCTS+1 value contained in the replicated membership table for its entry.

Further, if the tables were restored to a prior version and the timer was set backwards, the received membership table is checked to see if the LCTS is greater than the LCTS recorded and the timestamp is set to the greater value. For multiple joiners, this processing is performed relative to all membership tables, the current member and all of the joiners. It is detected during delta processing because the later timestamp is in a delta. Thus, the logic is: if row.CL==this member && row.CTS>this member's MT [this member], update timer to be monotonically increasing. (Note that this restores the timestamp to the last CTS for which the member was CL. It is possible that changes were lost when the data table was replaced, if no other member has them recorded.)

An example of processing associated with a forgetful member is described below.

### EXAMPLE 3

### Forgetful Member (e.g., Node)

| Time | Actions |
|---|---|
| 16:00 | N1 and N2 are defined nodes. |
| 20:36 | N1 and N2 are up and running, with N1 as the master. |
| 23:45 | A backup image is cut to tape. |
| 00:01 | A change is made (C1). |
| 00:45 | N1 dies, N2 becomes the master. |
| 01:15 | Another change is made (C2). |
| 02:15 | A human stops N2. |
| 02:23 | N1 is scratched and is re-loaded from the backup tape. |
| 03:02 | N1 is started. |
| 03:04 | N2 is started and joins with N1. Both C1 and C2 changes are only |
| | on N2. |

Similar to the above examples, when N2 computes its delta, both C1 and C2 are in the delta because the membership table restored is prior to the changes having been made, the LCTS for both N1 and N2 are from before the first backup occurred. Changes C1 and C2 are after that backup, so when N2 joins, N2 will correctly place C1 and C2 in its delta. N1 accepts both changes because the CTS for each row is greater than its LCTS for that row's CL, and N1's CTS for those rows is less than the LCTS that N2 has for those rows CL.

Described in detail above is reconciliation processing used to provide consistent information between independently updated entries, such as cluster members. In addition to the above, there are two situations addressed herein. One situation is when a row in a table is deleted and another situation is handling a deleted member.

When a row in a data table is deleted, it is marked as having been deleted, but is maintained in the data table. One way of handling such deleted rows is to disallow changes once a row has been deleted. Thus, if delta changes are detected, the changes are ignored and the row remains as being deleted. A row which has been deleted is retained until all members of the cluster are present at which time these “pending delete” rows are removed from the data tables which are replicated to the joining members. If a row is deleted while all members are present, there is no need to retain the row as “pending” and the row may be removed.

A deleted row is handled like any other data row. It includes a timestamp indicating the time the deletion is made, and is detected as a delta and processed during the join processing. One potential mechanism is to treat a deletion as taking precedence over the change. Thus, if a delta change is detected to the row during the conflict resolution, the delete is processed, instead of a change.

If a deleted row is added back into a table (the key for the row is the same as the key of the deleted row), the row is retained, if no member has recorded a pending delete for that row. Other mechanisms exist which allow the correct processing in these cases by allowing the conflict resolution process to determine which row should be retained.

In one embodiment, the deleted rows are accumulated until each member has joined the cluster. If all the members are present in the cluster, then it is known that each of the members has seen the deletions and the deletes can be discarded.

When a member is deleted, it is marked as deleted in the membership table and it is kept in the membership table until all the members have joined. The deleted member is maintained in the membership table, since its member id and timestamp may be in the data tables, and that information is used to determine deltas. The deleted member, however, is not counted in the number of members needed to discard either a deleted row or the deleted member.

When all defined members have joined the cluster, the deleted member is discarded from the membership table. The data tables are processed to remove the deleted member's entries. The rows having the deleted member as the change leader value, have their timestamps replaced to indicate that the current cluster member processing the join is the change leader and the current timestamp is the changed timestamp, prior to the table being replicated, so that no data table rows refer to the deleted member. This processing is performed atomically, such that the member is deleted from the membership table and the timestamp labels are changed atomically. If one of those fails, then they both fail.

In a further embodiment, the case of added members is also handled. Here, the membership table on one member has more entries than on another member. In this case, if the timestamp is for a change leader that is not present in the membership table, it is assumed to be a delta. The entry is added to the membership table, when the membership table entries are resolved.

In yet a further embodiment, instead of separate nodes individually joining, two subclusters that were created by a sunder are coming back together after the sunder is fixed. In this scenario, one of the members from one of the subclusters is considered the current member, and one of the members in the other subcluster is considered the joiner. All members in the joining subcluster do not need to process the merge steps, but do process the delta application and commit. (Note, it is possible that more than two subclusters are merging, and thus, there can still be multiple joiners—one from each subcluster other than the one the chosen current member is in.)

Described in detail above is a capability for facilitating reconciliation of independently updated distributed data of a communications environment. To reconcile the data, locally monotonically increasing values are employed. One example of such values are local timestamps. These timestamps are monotonically increasing, so that it is guaranteed that a future timestamp that is used in the updating precedes an earlier timestamp. By using locally monotonically increasing values, advantageously updates are reconciled without the need for a centralized update log, a centralized data server, shared disk or other shared medium, or hardware time clocks. Further, the reconciliation is performed without the requirement of a quorum.

In one or more aspects of the present invention, persistent data is replicated among a plurality of communicating nodes in such a manner that allows for the nodes to correctly identify both unambiguously updated data entries and ambiguously updated entries when the data may have been updated by any subset of the nodes not in communication with the remaining nodes over any time period including nodes that are deleted from the set of nodes, data entries deleted on some of the nodes, and detection of the lost data from a node.

Although examples are described above, many variations can be made without departing from the spirit of the present invention. For example, environments other than those described herein may incorporate and use one or more aspects of the present invention. For instance, although one or more aspects of the present invention are described with reference to a clustered environment, this is only one example. Any environment that has independently updated data that is to be reconciled can use one or more aspects of the present invention. Further, the members of the cluster or other environments can be other than nodes, such as virtual machines or other types of entities. Moreover, in other embodiments, one or more optimizations or other changes may be made in order to perform the join processing or other processing used to reconcile the independently updated data. In yet other examples, additional, different or less logic may be a part of the reconciliation component. Many other variations are possible.

Further, although the examples use timestamps, any monotonically increasing values may be used, including, but not limited to counters. Timestamps are just one example.

The capabilities of one or more aspects of the present invention can be implemented in software, firmware, hardware or some combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating reconciliation of data of a distributed communications environment, said method comprising:
determining whether one set of distributed data of the distributed communications environment and another set of distributed data of the distributed communications environment are consistent, wherein said determining comprises employing one or more locally monotonically increasing values in the determining; and
updating at least one of the one set of distributed data and the another set of distributed data, in response to the determining, to reconcile one or more inconsistencies between the one set of distributed data and the another set of distributed data.

2. The method of claim 1, wherein said employing comprises comparing a locally monotonically increasing value of the one set of distributed data with a locally monotonically increasing value of the another set of distributed data.

3. The method of claim 1, wherein said distributed communications environment comprises a clustered environment, said one set of distributed data comprises data of one member of a cluster of the clustered environment and said another set of distributed data comprises data of another member of the cluster.

4. The method of claim 3, wherein the one member comprises a current member of the cluster and the another member comprises a joining member of the cluster, and wherein said employing comprises:
comparing a locally monotonically increasing value of the joining member and a locally monotonically increasing value obtained from a membership data structure of the current member to determine if the joining member has one or more deltas, wherein a value associated with the locally monotonically increasing value of the joining member is an index into the membership data structure of the current member to obtain the locally monotonically increasing value from the membership data structure of the current member; and
comparing a locally monotonically increasing value of the current member and a locally monotonically increasing value obtained from a membership data structure of the joining member to determine if the current member has one or more deltas, wherein a value associated with the locally monotonically increasing value of the current member is an index into the membership data structure of the joining member to obtain the locally monotonically increasing value from the membership data structure of the joining member.

5. The method of claim 4, wherein the value to index into the membership data structure of the current member comprises an indication of a change leader for data associated with the locally monotonically increasing value of the joining member, and wherein the value to index into the membership data structure of the joining member comprises an indication of a change leader for data associated with the locally monotonically increasing value of the current member.

6. The method of claim 1, wherein the distributed communications environment comprises a clustered environment, said one set of distributed data comprises data of a current member of a cluster of the clustered environment and said another set of distributed data comprises data of a joining member of the cluster, and wherein the employing comprises comparing a locally monotonically increasing time value of the current member and a locally monotonically increasing time value of the joining member to determine whether one or more of the current member and the joining member has one or more deltas relative to the other.

7. The method of claim 6, wherein the comparing is performed in response to a comparison of a change leader of the current member with a change leader of the joining member indicating equality.

8. The method of claim 1, wherein the one set of distributed data is maintained on one communicating node of the distributed communications environment, and the another set of distributed data is to be a replicated set of data of said one set of distributed data and is maintained on another communicating node of the distributed communications environment, and wherein one or more of the inconsistencies exist as a result of updating at least one of the one set of distributed data and the another set of distributed data when the one communicating node and the another communicating node were not in communication with one another.

9. A method of facilitating reconciliation of data of a clustered communications environment, said method comprising:
initiating by a joining member a join to a cluster of the clustered communications environment, said cluster comprising at least one current member;
providing by a current member of the at least one current member a current membership data structure to the joining member;
determining by the joining member a set of deltas, said set of deltas comprising zero or more data inconsistencies between the joining member and the current member, said determining employing at least one locally monotonically increasing value;
providing by the joining member the set of deltas and a joining member's membership data structure to the current member;
determining by the current member a set of deltas, said set of deltas comprising zero or more data inconsistencies between the current member and the joining member, said determining employing at least one locally monotonically increasing value;
resolving by the current member zero or more conflicts between the joining member's set of deltas and the current member's set of deltas to provide a resolved set of deltas; and
providing the resolved set of deltas to one or more members of the cluster, including the joining member.

10. The method of claim 9, wherein the determining deltas by the joining member comprises:
selecting a data row from a data structure of the joining member;
determining whether the current member was present in the cluster when the data row was last changed, said determining employing at least one locally monotonically increasing value; and
repeating the selecting and determining for zero or more data rows of the data structure.

11. The method of claim 9, wherein the determining deltas by the current member comprises:
selecting a data row from a data structure of the current member;
determining whether the joining member was present in the cluster when the data row was last changed, said determining employing at least one locally monotonically increasing value; and
repeating the selecting and determining for zero or more data rows of the data structure.

12. The method of claim 9, wherein the initiating comprising concurrently joining a plurality of joining members to the cluster.

13. The method of claim 9, wherein at least one set of deltas of the joining member set of deltas and the current member set of deltas comprises a deleted row, and wherein the deleted row is maintained until all inactive members of the cluster have joined the cluster.

14. The method of claim 9, wherein a plurality of joining members having replicated and consistent data with one another are to join the cluster, and wherein a single joining member of the plurality of joining members is associated with the initiating, providing by a current member, determining by the joining member, providing by the joining member, determining by the current member, and the resolving.

15. A system of facilitating reconciliation of data of a distributed communications environment, said system comprising:
means for determining whether one set of distributed data of the distributed communications environment and another set of distributed data of the distributed communications environment are consistent, wherein said means for determining comprises means for employing one or more locally monotonically increasing values in the determining; and
means for updating at least one of the one set of distributed data and the another set of distributed data, in response to the determining, to reconcile one or more inconsistencies between the one set of distributed data and the another set of distributed data.

16. The system of claim 15, wherein said means for employing comprises means for comparing a locally monotonically increasing value of the one set of distributed data with a locally monotonically increasing value of the another set of distributed data.

17. The system of claim 15, wherein said distributed communications environment comprises a clustered environment, said one set of distributed data comprises data of a current member of a cluster of the clustered environment and said another set of distributed data comprises data of a joining member of the cluster, and wherein said means for employing comprises:
means for comparing a locally monotonically increasing value of the joining member and a locally monotonically increasing value obtained from a membership data structure of the current member to determine if the joining member has one or more deltas, wherein a value associated with the locally monotonically increasing value of the joining member is an index into the membership data structure of the current member to obtain the locally monotonically increasing value from the membership data structure of the current member; and
mean for comparing a locally monotonically increasing value of the current member and a locally monotonically increasing value obtained from a membership data structure of the joining member to determine if the current member has one or more deltas, wherein a value associated with the locally monotonically increasing value of the current member is an index into the membership data structure of the joining member to obtain the locally monotonically increasing value from the membership data structure of the joining member.

18. The system of claim 17, wherein the value to index into the membership data structure of the current member comprises an indication of a change leader for data associated with the locally monotonically increasing value of the joining member, and wherein the value to index into the membership data structure of the joining member comprises an indication of a change leader for data associated with the locally monotonically increasing value of the current member.

19. The system of claim 15, wherein the distributed communications environment comprises a clustered environment, said one set of distributed data comprises data of a current member of a cluster of the clustered environment and said another set of distributed data comprises data of a joining member of the cluster, and wherein the employing comprises comparing a locally monotonically increasing time value of the current member and a locally monotonically increasing time value of the joining member to determine whether one or more of the current member and the joining member has one or more deltas relative to the other.

20. The system of claim 19, wherein the comparing is performed in response to a comparison of a change leader of the current member with a change leader of the joining member indicating equality.

21. A system of facilitating reconciliation of data of a clustered communications environment, said system comprising:
a joining member to initiate a join to a cluster of the clustered communications environment, said cluster comprising at least one current member;
a current member of the at least one current member to provide a current membership data structure to the joining member;
the joining member to determine a set of deltas, said set of deltas comprising zero or more data inconsistencies between the joining member and the current member, the determining employing at least one locally monotonically increasing value;
the joining member to provide the set of deltas and a joining member's membership data structure to the current member;
the current member to determine a set of deltas, said set of deltas comprising zero or more data inconsistencies between the current member and the joining member, the determining employing at least one locally monotonically increasing value;
the current member to resolve zero or more conflicts between the joining member's set of deltas and the current member's set of deltas to provide a resolved set of deltas; and
one or more members of the cluster, including the joining member, to which the resolved set of deltas is provided.

22. The system of claim 21, wherein the joining member to determine the set of deltas comprises the joining member to:
select a data row from a data structure of the joining member;
determine whether the current member was present in the cluster when the data row was last changed, the determining employing at least one locally monotonically increasing value; and
repeat the selecting and determining for zero or more data rows of the data structure.

23. The system of claim 21, wherein the current member to determine the set of deltas comprises the current member to:
select a data row from a data structure of the current member;
determine whether the joining member was present in the cluster when the data row was last changed, the determining employing at least one locally monotonically increasing value; and
repeat the selecting and determining for zero or more data rows of the data structure.

24. The system of claim 21, wherein a plurality of joining members having replicated and consistent data with one another are to join the cluster, and wherein a single joining member of the plurality of joining members is associated with the initiating, providing by a current member, determining by the joining member, providing by the joining member, determining by the current member, and the resolving.

25. An article of manufacture comprising:
at least one computer usable medium having computer readable program code logic to facilitate reconciliation of data of a distributed communications environment, the computer readable program code logic comprising:
determine logic to determine whether one set of distributed data of the distributed communications environment and another set of distributed data of the distributed communications environment are consistent, wherein said determine logic comprises employ logic to employ one or more locally monotonically increasing values in the determining; and
update logic to update at least one of the one set of distributed data and the another set of distributed data, in response to the determining, to reconcile one or more inconsistencies between the one set of distributed data and the another set of distributed data.

26. The article of manufacture of claim 25, wherein said employ logic comprises compare logic to compare a locally monotonically increasing value of the one set of distributed data with a locally monotonically increasing value of the another set of distributed data.

27. The article of manufacture of claim 25, wherein said distributed communications environment comprises a clustered environment, said one set of distributed data comprises data of a current member of a cluster of the clustered environment and said another set of distributed data comprises data of a joining member of the cluster, and wherein said employ logic comprises:
compare logic to compare a locally monotonically increasing value of the joining member and a locally monotonically increasing value obtained from a membership data structure of the current member to determine if the joining member has one or more deltas, wherein a value associated with the locally monotonically increasing value of the joining member is an index into the membership data structure of the current member to obtain the locally monotonically increasing value from the membership data structure of the current member; and
compare logic to compare a locally monotonically increasing value of the current member and a locally monotonically increasing value obtained from a membership data structure of the joining member to determine if the current member has one or more deltas, wherein a value associated with the locally monotonically increasing value of the current member is an index into the membership data structure of the joining member to obtain the locally monotonically increasing value from the membership data structure of the joining member.

28. The article of manufacture of claim 27, wherein the value to index into the membership data structure of the current member comprises an indication of a change leader for data associated with the locally monotonically increasing value of the joining member, and wherein the value to index into the membership data structure of the joining member comprises an indication of a change leader for data associated with the locally monotonically increasing value of the current member.

29. The article of manufacture of claim 25, wherein the distributed communications environment comprises a clustered environment, said one set of distributed data comprises data of a current member of a cluster of the clustered environment and said another set of distributed data comprises data of a joining member of the cluster, and wherein the employ logic comprises compare logic to compare a locally monotonically increasing time value of the current member and a locally monotonically increasing time value of the joining member to determine whether one or more of the current member and the joining member has one or more deltas relative to the other.

30. The article of manufacture of claim 29, wherein the comparing is performed in response to a comparison of a change leader of the current member with a change leader of the joining member indicating equality.

31. An article of manufacture comprising:
at least one computer usable medium having computer readable program code logic to facilitate reconciliation of data of a clustered communications environment, the computer readable program code logic comprising:
initiate logic to initiate by a joining member a join to a cluster of the clustered communications environment, said cluster comprising at least one current member;
provide logic to provide by a current member of the at least one current member a current membership data structure to the joining member;
determine logic to determine by the joining member a set of deltas, said set of deltas comprising zero or more data inconsistencies between the joining member and the current member, the determining employing at least one locally monotonically increasing value;
provide logic to provide by the joining member the set of deltas and a joining member's membership data structure to the current member;
determine logic to determine by the current member a set of deltas, said set of deltas comprising zero or more data inconsistencies between the current member and the joining member, said determining employing at least one locally monotonically increasing value;
resolve logic to resolve by the current member zero or more conflicts between the joining member's set of deltas and the current member's set of deltas to provide a resolved set of deltas; and
provide logic to provide the resolved set of deltas to one or more members of the cluster, including the joining member.

32. The article of manufacture of claim 31, wherein the determine logic to determine deltas by the joining member comprises:
select logic to select a data row from a data structure of the joining member;
determine logic to determine whether the current member was present in the cluster when the data row was last changed, said determining employing at least one locally monotonically increasing value; and
repeat logic to repeat the selecting and determining for zero or more data rows of the data structure.

33. The article of manufacture of claim 31, wherein the determine logic to determine deltas by the current member comprises:
select logic to select a data row from a data structure of the current member;
determine logic to determine whether the joining member was present in the cluster when the data row was last changed, said determining employing at least one locally monotonically increasing value; and
repeat logic to repeat the selecting and determining for zero or more data rows of the data structure.
